(19) United States
(12) Patent Application Publication
(10) Pub. No.: US 2026/0142510 A1
(43) Pub. Date: May 21, 2026

(54) ROTATING ELECTRIC MACHINE

(71) Applicant: TOYOTA JIDOSHA KABUSHIKI KAISHA, Toyota-shi (JP)

(72) Inventors: Hazuki URYU, Toyota-shi (JP); Keiichi KANESHIGE, Toyota-shi (JP); Yingxue BAI, Toyota-shi (JP)

(73) Assignee: TOYOTA JIDOSHA KABUSHIKI KAISHA, Toyota-shi (JP)

(21) Appl. No.: 19/393,806

(22) Filed: Nov. 19, 2025

(30) Foreign Application Priority Data
Nov. 21, 2024 (JP) 2024-203191

(51) Int. Cl. H02K 1/20; H02K 9/19

(52) U.S. Cl. CPC H02K 1/20; H02K 9/19

(57) ABSTRACT

A rotating electric machine includes refrigerant passages respectively opened at one end surface and the other end surface of the stator core; a refrigerant guide member that guides refrigerant from a refrigerant supply portion of the case to one coil end portion side and the stator core side; a first sealing member that seals between one end portion of the refrigerant guide member opposite the stator core side and the case; and a second sealing member with a plurality of hole portions formed at intervals in the circumferential direction to communicate with an opening in the one end surface of the stator core of the corresponding refrigerant passage, that seals between the one end surface of the stator core and the other end portion of the stator core side of the refrigerant guide member, as well as sealing between the one end surface of the stator core and the case.

### CROSS-REFERENCE TO RELATED APPLICATION

The present disclosure claims priority to Japanese Patent Application No.2024-203191 filed on November 21, 2024, which is incorporated herein by reference in its entirety including specification, drawings and claims.

### TECHNICAL FIELD

The present disclosure relates to a rotating electric machine that includes a case, an annular stator disposed in the case, and a rotor rotatably disposed within the stator.

### BACKGROUND

The conventionally known starter for a rotating electric machine includes a support member that supports a stator core on the outer radial side of the stator core (see, for example, Patent Literature 1). The support member of the stator includes an annular oil passage forming portion and an annular outer circumference support portion. The oil passage forming portion includes a first oil passage forming portion and a second oil passage forming portion that are axially separated, and a circumferential oil passage that extends around the entire circumference between the two portions, and is integrally bonded to an outer circumference surface of the stator core. The first and second oil passage forming portions have axial oil passages that extend in a straight line or are formed by connecting a plurality of holes. The outer circumference support portion includes a recess that forms an oil introduction passage and a tub portion that protrudes radially inward and extends axially to fill notches formed in the first oil passage forming portion and the like. The outer circumference support portion is integrally bonded to an outer circumference surface of the oil passage forming portion. The oil introduced into the oil introduction passage of the outer circumference support portion flows circumferentially along the circumferential oil passage, and part of the oil flowing circumferentially is captured by the tub portion and flows into the axial oil passages of the first oil passage forming portion and the like. The oil in the axial oil passage flows out from an opening of the axial oil passage and is dripped onto a coil end portion of the stator coil. This makes it possible to cool the coil end portion with oil.

### CITATION LIST

### PATENT LITERATURE

Patent Literature 1 Japanese Patent Application Laid Open No. 2023-125010

### SUMMARY

In the above mentioned conventional stator, a gap may be formed between the outer circumference surface of the stator core and the oil passage forming portion of the support member, and/or between the outer circumference surface of the oil passage forming portion and the outer circumference support portion. When oil flows into such a gap, the coil end portion may not be sufficiently supplied with oil and may not be cooled sufficiently. Further, increasing the number of seal members to seal the gap between the stator core and the oil passage forming portion, and/or the gap between the oil passage forming portion and the outer circumference support portion, etc., may result in an increase in the number of parts and a consequent increase in the cost of the rotating electric machine.

A main object of the present disclosure is to allow the coil end portion of the stator coil to be cooled effectively while suppressing the cost of the rotating electric machine.

A rotating electric machine of the present disclosure includes a case; an annular stator that is disposed in the case; a rotor that is rotatably disposed within the stator; a plurality of refrigerant passages; a refrigerant guide member, a first sealing member; and a second sealing member. The plurality of refrigerant passages are formed in a stator core of the stator at intervals in a circumferential direction so as to extend from one end surface of the stator core to the other end surface of the stator core. The plurality of refrigerant passages are respectively opened at the one end surface and the other end surface of the stator core. The refrigerant guide member includes a cylindrical portion that surrounds one coil end portion of the stator coil and a plurality of refrigerant holes formed in the cylindrical portion at intervals in the circumferential direction. The refrigerant guide member guides refrigerant from a refrigerant supply portion formed in the case to the one coil end portion side and the stator core side. The first sealing member seals between one end portion of the refrigerant guide member opposite the stator core side and the case. The second sealing member includes a plurality of hole portions formed at intervals in the circumferential direction. Each of the hole portions communicates with an opening in the one end surface of the stator core of the corresponding refrigerant passage. Further, the second sealing member seals between the one end surface of the stator core and the other end portion of the stator core side of the refrigerant guide member and seals between the one end surface of the stator core and the case.

In the rotating electric machine, part of the refrigerant from the refrigerant supply portion is guided to the one coil end portion side via the plurality of refrigerant holes of the refrigerant guide member. Further, part of the refrigerant from the refrigerant supply portion is guided to the stator core side by the refrigerant guide member, and flows into each refrigerant passage via the plurality of hole portions of the second seal member and the opening on the one end surface of the stator core. The refrigerant that flows into each refrigerant passage flows out from the opening on the other end surface of the stator core and is supplied to the other coil end portion of the stator coil. Furthermore, the first seal member seals between the one end portion of the refrigerant guide member and the case, and the second seal member seals both between the stator core and the other end portion of the refrigerant guide member and between the stator core and the case. This allows the refrigerant from the refrigerant supply portion to be satisfactorily prevented from flowing between the one end portion of the refrigerant guide member and the case, between the stator core and the other end portion of the refrigerant guide member and between the stator core and the case, and enables the refrigerant to be sufficiently supplied to both coil ends of the stator coil. Furthermore, by making the second seal member seal both between the stator core and the other end of the refrigerant guide member and between the stator core and the case, the number of parts in the rotating electric machine is reduced. As a result, the coil ends of the stator coil are cooled well while suppressing the cost increase of the rotating electric machine.

### BRIEF DESCRIPTION OF DRAWINGS

FIG. 1 is a schematic configuration diagram illustrating the rotating electric machine of the present disclosure;

FIG. 2 is a plan view illustrating a plate member that forms the stator core of the rotating electric machine of the present disclosure;

FIG. 3 is a plan view illustrating another plate member that forms the stator core of the rotating electric machine of the present disclosure;

FIG. 4 is a plan view illustrating yet another plate member that forms the stator core of the rotating electric machine of the present disclosure;

FIG. 5 is a perspective view illustrating a refrigerant guide member of the rotating electric machine of the present disclosure; and

FIG. 6 is a cross-sectional view illustrating an essential portion of the rotating electric machine of the present disclosure.

### DESCRIPTION OF EMBODIMENTS

The following describes some aspects of the present disclosure with reference to drawings.

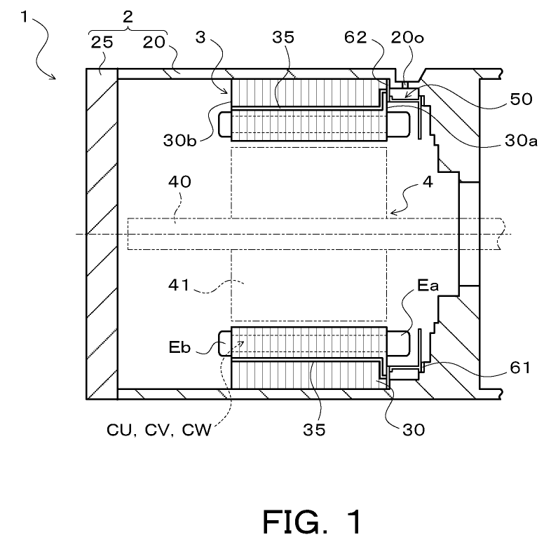

FIG. 1 is a schematic configuration diagram illustrating a rotating electric machine 1 of the present disclosure. The rotating electric machine 1 shown in the figure is a three-phase alternating current motor that is used as a driving source or a generator for an electric vehicle (BEV), a fuel cell vehicle (FCV), or a hybrid electric vehicle (PHEV, HEV). As shown in the figure, the rotating electric machine 1 includes a case 2, an annular stator 3, and a rotor 4 that is rotatably disposed within the stator 3. The case 2 includes a cylindrical case body 20, and a cover 25 that is fixed to the case body 20 via a plurality of bolts and the like that are not shown in the figure so as to close the open end (left end in FIG. 1) of the case body 20. The case body 20 and the cover 25 are formed of a metal such as an aluminum alloy.

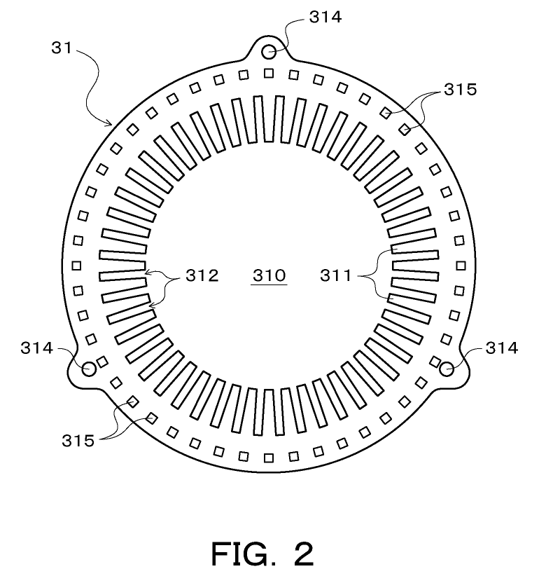

The stator 3 of the rotating electric machine 1 includes a stator core 30 and three-phase (three) stator coils CU, CV, and CW wound around the stator core 30. The stator core 30 is formed by laminating and caulking together a plurality of electromagnetic steel plates 31, 32, and 33, as shown in FIGS. 2, 3, and 4 in the stacking direction. The stator core 30 may be formed into an annular shape by, for example, press-forming and sintering ferromagnetic powder.

As shown in FIG. 2, the electromagnetic steel plate 31 includes a central hole 310, a plurality of protrusions 311, a plurality of notches 312 (in this embodiment, for example, 48), a plurality of bolt holes 314 (in this embodiment, for example, 3), and a plurality of holes 315 (in this embodiment, for example, 48). The plurality of protrusions 311 extend in a radial direction from an annular outer circumference portion of the electromagnetic steel plate 31 toward the central hole 310 (axis) and are adjacent to each other at a predetermined interval in a circumferential direction. The plurality of notches 312 respectively extend in a radial direction between the adjacent protrusions 311 and are arranged in a circumferential direction at predetermined intervals. Each of the notches 312 are opened at the central hole 310. The plurality of bolt holes 314 are formed at intervals (for example, equally spaced) on the outer circumference portion of the electromagnetic steel plate 31. The plurality of holes 315 are formed at intervals (equally spaced) in the circumferential direction so as to be close to the outer circumference of the electromagnetic steel plate 31 on the radial outer side of a proximal end of each protrusion 311.

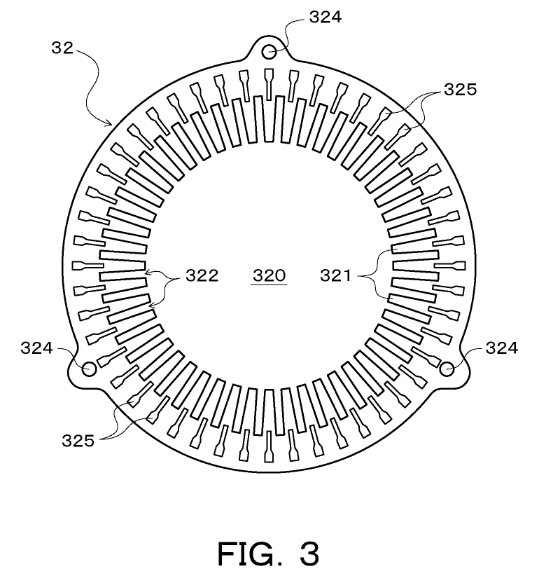

The electromagnetic steel plate 32 includes a central hole 320, a plurality of protrusions 321, a plurality of notches 322 (in this embodiment, for example, 48), a plurality of bolt holes 324 (in this embodiment, for example, 3), and a plurality of slits 325 (in this embodiment, for example, 48), as shown in FIG. 3. The plurality of protrusions 321 extend in the radial direction from an annular outer circumference portion of the electromagnetic steel plate 32 toward the central hole 320 (axis) and are adjacent to each other at a predetermined interval in the circumferential direction. The plurality of notches 322 respectively extend in the radial direction between the adjacent protrusions 321 and are arranged in the circumferential direction at predetermined intervals. Each of the notches 322 are opened at the central hole 320. The plurality of bolt holes 324 are formed at intervals (for example, evenly spaced) on the outer circumference portion of the electromagnetic steel plate 32. The plurality of slits 325 are formed at intervals (for example, evenly spaced) so as to extend from a proximal end of each protrusion 321 to the vicinity of the outer circumference of the electromagnetic steel plate 32 and to communicate with the hole 315 of the electromagnetic steel plate 31.

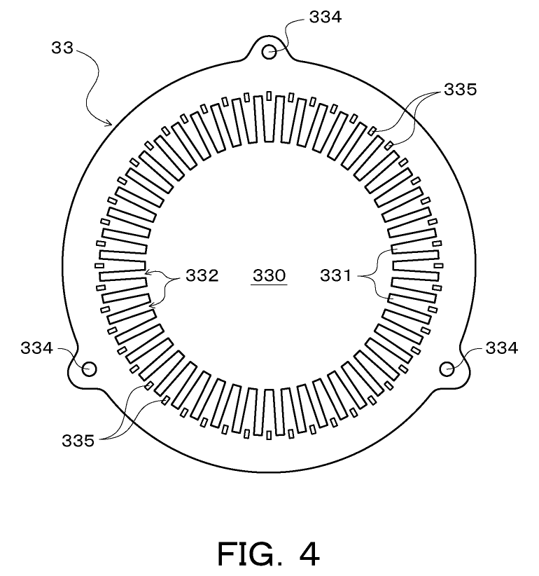

The electromagnetic steel plate 33 includes a central hole 330, a plurality of protrusions 331, a plurality of notches 332 (in this embodiment, for example, 48), a plurality of bolt holes 334 (in this embodiment, for example, 3), and a plurality of holes 335 (in this embodiment, for example, 48), as shown in FIG. 4. The plurality of protrusions 331 extend in the radial direction from the annular outer circumference portion of the electromagnetic steel plate 33 toward the central hole 330 (axis) and are adjacent to each other at a predetermined interval in the circumferential direction. The plurality of notches 332 respectively extend in the radial direction between the adjacent protrusions 331 and are arranged in the circumferential direction at predetermined intervals. Each of the notches 332 are opened at the central hole 330. The plurality of bolt holes 334 are formed at intervals (for example, evenly spaced) on the outer circumference portion of the electromagnetic steel plate 33. The plurality of holes 335 are formed at intervals (evenly spaced) in the circumferential direction so as to communicate with an inner end portion of the slit 325 of the electromagnetic steel plate 32 in the vicinity of a proximal end of each protrusion 331.

In this embodiment, a relatively small number of electromagnetic steel plates 31 are stacked to form a lead side end portion of the stator core 30. Further, a large number of electromagnetic steel plates 33 are stacked to form the majority of the stator core 30 and an opposite lead side end portion. Furthermore, the plurality of electromagnetic steel plates 32 are stacked between the plurality of electromagnetic steel plates 31 and the plurality of electromagnetic steel plates 33. When the respective multiple electromagnetic steel plates 31, 32, and 33 are connected, the plurality of protrusions 311, 321, and 331 overlap to form a plurality of teeth of the stator core 30, and the plurality of notches 312, 322, and 332 overlap to form a plurality of slots of the stator core 30.

Further, in the stator core 30, a plurality of bolt holes respectively extending in an axial direction are formed by the bolt holes 314, 324, and 334 of the electromagnetic steel plates 31, 32, and 33 being communicated with each other. Furthermore, in the stator core 30, the holes 315 of the electromagnetic steel plate 31, the slits 325 of the electromagnetic steel plate 32, and the holes 335 of the electromagnetic steel plate 33 are communicated with each other to form a plurality (in this embodiment, for example, 48) of refrigerant passages 35 spaced apart in the circumferential direction. Each refrigerant passage 35 extends from one end surface (the right end surface in FIG. 1) 30a of the lead side of the stator core 30 to the other end surface (the left end surface in FIG. 1) 30b of the opposite lead side, and is opened at the one end surface 30a and the other end surface 30b.

The stator coils CU, CV, and CW of the stator 3 are formed by electrically bonding a plurality of segment coils (coil wires) not shown in the figure, and are connected to each other by a star connection (Y connection), for example. The segment coils are electrical conductors formed by bending a rectangular wire with an insulation coating, for example enamel resin, on its surface into an approximately U-shape, and include a pair (two) of legs. The two legs of each segment coil are inserted into different slots of the stator core 30, and the legs of each segment coil that protrude from one end surface 30a of the stator core 30 are bent.

After the bending process is completed, a tip of each segment coil is electrically welded to the tip of another corresponding segment coil that is adjacent to it in the radial direction of the stator core 30. Thus, the plurality of stator coils CU, CV, and CW are wound around the stator core 30. Further, an annular coil end portion Ea of the stator coils CU, CV, and CW protrudes from the one end surface 30a of the stator core 30, and an annular coil end portion Eb of the stator coils CU, CV, and CW protrudes from the other end surface 30b of the stator core 30.

The rotor 4 of the rotating electric machine 1 is a so-called embedded magnet type (IPM type) rotor. As shown in FIG. 1, the rotor 4 includes a rotor shaft 40, a rotor core 41 fixed to the rotor shaft 40, and a plurality of permanent magnets (not shown in the figure) embedded in the rotor core 41 to form a plurality of magnetic poles (for example, eight poles in this embodiment). The rotor 4 is disposed in the case 2 such that the rotor core 41 is rotatable within the stator 3 via an air gap. The rotor shaft 40 is rotatably supported by a plurality of bearings not shown in the figure, which are held by the case 2.

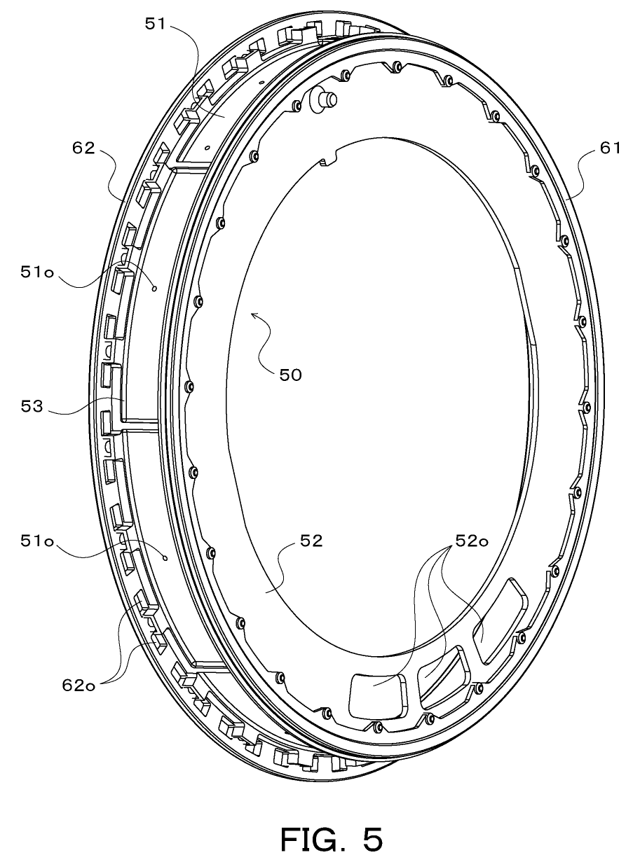

In addition, the rotating electric machine 1 includes a refrigerant guide member 50, as shown in FIG. 1. The refrigerant guide member 50 is formed of plastics, etc., and includes an annular cylindrical portion 51, an annular side plate portion 52, and an annular flange portion 53, as shown in FIG. 5. The cylindrical portion 51 has an inner diameter that is larger than an outer diameter of the one coil end portion Ea of the stator coil CU, CV, CW, an outer diameter that is smaller than an outer diameter of the stator core 30, and an axial length that is longer than a protrusion length (axial length) of the coil end portion Ea from the one end surface 30a of the stator core 30. Further, the cylindrical portion 51 includes a plurality of refrigerant holes (through holes) 51o formed at intervals in the circumferential direction.

The side plate portion 52 of the refrigerant guide member 50 extends from one end portion (the right end portion in FIG. 5) of the cylindrical portion 51 in a radially inward direction and a radially outward direction. In this embodiment, the side plate portion 52 has an inner diameter that is slightly larger than an inner diameter of the stator core 30 and an outer diameter that is slightly larger than an outer diameter of the cylindrical portion 51. Further, a plurality of refrigerant discharge holes 52o are formed in a lower portion of the side plate portion 52. The flange portion 53 extends radially outward from the other end portion (left end portion in FIG. 5) of the cylindrical portion 51. In this embodiment, the flange portion 53 has an outer diameter that is slightly smaller than an outer diameter of the side plate portion 52.

As shown in FIG. 5, an annular first gasket (first sealing member) 61 is attached to the outer circumference portion of the side plate portion 52 of the refrigerant guide member 50. In this embodiment, the first gasket 61 is formed, for example, of acrylic rubber material and the like and has an outer diameter that is approximately the same as the outer diameter of the side plate portion 52. The first gasket 61 includes a plurality of hole portions into which a corresponding projection formed on the side plate portion 52 is press-fitted, and is attached to the outer circumference portion of the side plate portion 52 to protrude on the side opposite to the cylindrical portion 51 side of the side plate portion 52.

Further, an annular second gasket (second sealing member) 62 is attached to the flange portion 53 of the refrigerant guide member 50. In this embodiment, the second gasket 62 is formed from an acrylic rubber material and the like and has an inner diameter that is approximately the same as the inner diameter of the cylindrical portion 51 and an outer diameter that is approximately the same as the outer diameter of the stator core 30. The second gasket 62 includes a plurality of hole portions into which a corresponding projection formed in the flange portion 53 is press-fitted, and is attached so as to extend radially outwardly on a surface opposite the side plate portion 52 side of the flange portion 53. Furthermore, the second gasket 62 has a plurality of hole portions 62o formed at intervals in the circumferential direction with the same pitch as the arrangement pitch of the holes 315 of the above-mentioned electromagnetic steel plate 31 such that the hole portions 62o are located on the outer radial side of the flange portion 53. Each hole portion 62o is formed such that it has an opening area larger than the hole 315 of the electromagnetic steel plate 31 under an installation state in which the second gasket 62 is compressed by a predetermined amount.

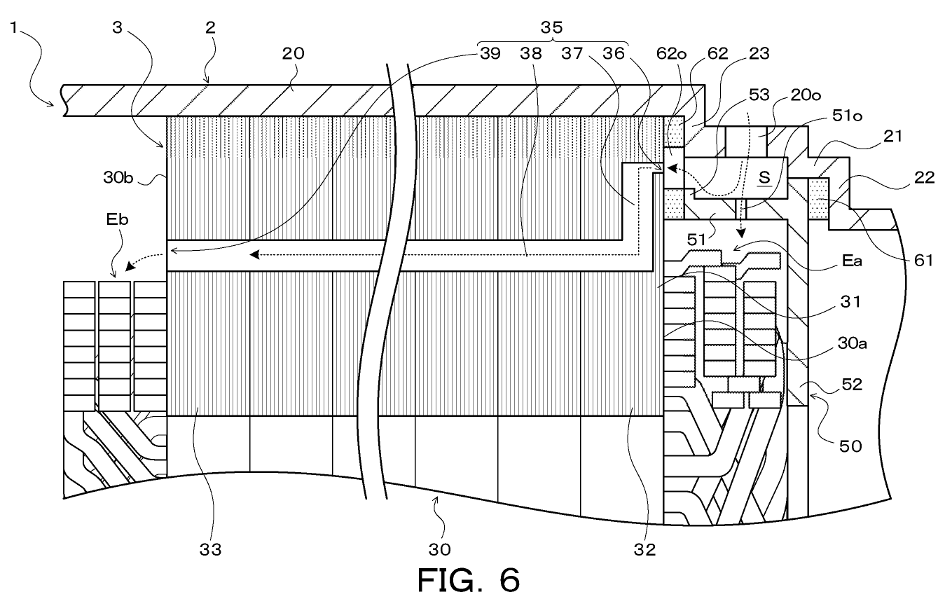

The refrigerant guide member 50 (assembly) with the first and second gaskets 61, 62 attached is fitted into a fitting portion (spigot fitting portion) 21 formed in the case body 20 of the case 2, as shown in FIG. 6. The fitting portion 21 is a cylindrical portion with an inner diameter slightly larger than the outer diameter of the side plate portion 52 of the refrigerant guide member 50 and that of the first gasket 61. The first gasket 61 and the side plate portion 52 of the refrigerant guide member 50 are fitted inside the fitting portion 21, and the first gasket 61 contacts an inner opposing portion 22 that extends radially inward from a tip of the fitting portion 21 (the right end in FIG. 6). In addition, an outer circumferential portion (portion on the radially outer side of the plurality of hole portions 62o) of the second gasket 62 comes into contact with an outer opposing portion 23 of the case body 20 that extends in the radial direction on the radially outer side of the above-mentioned inner opposing portion 22 and on the side of the cover 25 (left side in FIG. 6).

Further, an annular space S is formed between the cylindrical portion 51 of the refrigerant guide member 50 and the case body 20 in the radial direction to surround the cylindrical portion 51. As shown in FIG. 6, the space S communicates with at least one refrigerant supply hole (refrigerant supply portion) 20o formed in the case body 20, and lubricating cooling oil (lubricating cooling medium) for lubricating and cooling the rotating electric machine 1 is supplied to the refrigerant supply hole 20o from an oil pump and the like, not shown in the figure. A detent structure that restricts rotation of the refrigerant guide member 50 with respect to the case 2 is provided in the case body 20 and the refrigerant guide member 50.

As shown in FIG. 6, the above-mentioned stator 3 is assembled in the case body 20 such that the one coil end portion Ea is surrounded by the cylindrical portion 51 of the refrigerant guide member 50 at an interval in the radial direction, and the outer circumference portion of the one end surface 30a of the stator core 30 contacts the second gasket 62. Further, the stator 3 (stator core 30) is secured to the case body 20 (case 2) via bolts that are inserted through the plurality of bolt holes and are not shown in the figure.

Thus, the first gasket 61 is compressed (crushed) in response to the fastening of the stator 3 to the case body 20, and seals between the side plate portion 52, which forms one end of the refrigerant guide member 50 opposite the stator core 30 side, and the inner opposing portion 22 (case 2) of the case body 20. Similarly, the second gasket 62 is also compressed (crushed) in response to the fastening of the stator 3 to the case body 20. As a result, the second gasket 62 seals between the one end surface 30a of the stator core 30 and the flange portion 53 that forms the other end portion of the refrigerant guide member 50 on the stator core 30 side, and also seals between the one end surface 30a of the stator core 30 and the outer opposing portion 23 of the case body 20.

As shown in FIG. 6, each hole portion 62o of the second gasket 62 communicates with the space S and the corresponding refrigerant passage 35, which is opened at the one end surface 30a of the stator core 30. In this embodiment, an opening 36 of each refrigerant passage 35 in the one end surface 30a of the stator core 30 is defined by the holes 315 of the plurality of electromagnetic steel plates 31, and each opening 36 is located inside the corresponding hole portion 62o of the second gasket 62, and communicates with the above-mentioned space S through the hole portion 62o. In addition, each refrigerant passage 35 includes a radial passage 37 formed by the slits 325 of the plurality of electromagnetic steel plates 32 and an axial passage 38 formed by the holes 335 of the plurality of electromagnetic steel plates 33.

The radial passage 37 of each refrigerant passage 35 communicates with the corresponding opening 36, and extends radially inward from the corresponding opening 36 to communicate with the corresponding axial passage 38. That is, the opening 36 and the axial passage 38 of each refrigerant passage 35 communicate with each other via the radial passage 37. Further, the axial passage 38 of each refrigerant passage 35 extends in the axial direction from an inner end portion (one end surface 30a side) of the radial passage 37 toward the other end surface 30b of the stator core 30, and is opened near the outer circumference of the other coil end portion Eb of the stator coil CU, CV, CW on the other end surface 30b of the stator core 30.

During operation of the rotating electric machine 1 configured as described above, the lubricating cooling oil is supplied to the refrigerant supply hole 20o of the case body 20, and the lubricating cooling oil flows into the space S from the refrigerant supply hole 20o above. art of the lubricating cooling oil that flows into space S flows down along the cylindrical portion 51 of the refrigerant guide member 50, as shown by the dotted line in FIG. 6, and is supplied to the one coil end portion Ea of the stator coil CU, CV, CW through the plurality of refrigerant holes 51o of the cylindrical portion 51. Further, as shown by the dotted line in FIG. 6, part of the lubricating cooling oil that flows into the space S is guided to the stator core 30 side by the cylindrical portion 51 of the refrigerant guide member 50, and flows into each refrigerant passage 35 through the plurality of hole portions 62o of the second gasket 62 and the openings 36 on the one end surface 30a of the stator core 30.

The lubricating cooling oil that flows into each refrigerant passage 35 flows through the radial passage 37 and the axial passage 38, and flows out from the openings 39 on the other end surface 30b of the stator core 30 to be supplied to the other coil end portions Eb of the stator coils CU, CV, and CW. Furthermore, the first gasket 61 seals between the side plate portion 52 (one end portion) of the refrigerant guide member 50 on the side opposite the stator core 30 side and the inner opposing portion 22 of the case body 20. In addition, the second gasket 62 seals both between the one end surface 30a of the stator core 30 and the flange portion 53 (other end portion) on the stator core 30 side of the refrigerant guide member 50, and between the one end surface 30a of the stator core 30 and the outer opposing portion 23 of the case body 20.

This effectively prevents the lubricating cooling oil from the refrigerant supply hole 20o from flowing into the gap between the side plate portion 52 of the refrigerant guide member 50 and the inner opposing portion 22 of the case body 20, the gap between the stator core 30 and the flange portion 53 of the refrigerant guide member 50, and the gap between the stator core 30 and the outer opposing portion 23 of the case body 20, thereby enabling the lubricating cooling oil to be sufficiently supplied to both coil end portions Ea and Eb of the stator coil CU, CV, and CW. In addition, the second gasket 62 seals both between the stator core 30 and the flange portion 53 of the refrigerant guide member 50, and between the stator core 30 and the outer opposing portion 23 of the case body 20, thereby suppressing the increase in the number of parts of the rotating electric machine 1. As a result, the coil end portions Ea and Eb of the stator coils CU, CV and CW can be cooled effectively while suppressing the cost increase of the rotating electric machine 1. The lubricating cooling oil that has cooled the one coil end portion Ea of the stator coils CU, CV and CW is collected via the refrigerant discharge holes 52o of the refrigerant guide member 50 and the like, and is used again for lubricating and cooling the rotating electric machine 1. Further, the lubricating cooling oil that has cooled the other coil end portion Eb of the stator coils CU, CV and CW is also collected via an oil passage not shown in the figure and the like, and is reused for lubricating and cooling the rotating electric machine 1.

Each of the plurality of hole portions 62o of the second gasket 62 has the opening area larger than the opening 36 of each refrigerant passage 35 in the one end surface 30a of the stator core 30 in the above-mentioned installation state. This prevents the opening 36 from being closed by the second gasket 62 and ensures a sufficient amount of lubricating cooling oil supplied from the refrigerant supply hole 20o to the other coil end portion Eb of the stator coils CU, CV, CW via the plurality of refrigerant passages 35.

Furthermore, the first gasket 61 is attached to the outer circumference portion of the side plate portion 52 (one end portion) of the refrigerant guide member 50 and the second gasket 62 is attached to the flange portion 53 (other end portion) of the refrigerant guide member 50. This enables the first and second gaskets 61, 62 to be more easily assembled to the stator 3 and the case body 20 (case 2). The first and second gaskets 61, 62 do not necessarily need to be attached to the refrigerant guide member 50 and may be assembled separately to the stator 3 and the case body 20 (case 2).

The case body 20 includes the inner opposing portion 22 and the outer opposing portion 23. The inner opposing portion 22 opposes the side plate portion 52 (one end portion) of the refrigerant guide member 50 at an interval in the axial direction of the stator 3 on the opposite side of the stator core 30 side of the refrigerant supply hole 20o and inside the outer opposing portion 23 in the radial direction of the stator 3. The outer opposing portion 23 opposes the one end surface 30a of the stator core 30 at an interval in the axial direction of the stator 3 on the stator core 30 side of the refrigerant supply hole 20o. Furthermore, the first gasket 61 seals between the side plate portion 52 (one end portion) of the refrigerant guide member 50 and the inner opposing portion 22. The second gasket 62 seals between the one end surface 30a of the stator core 30 and the flange portion 53 of the refrigerant guide member 50 as well as between the one end surface 30a of the stator core 30 and the outer opposing portion 23. This enables variations in both the interval between the one end surface 30a of the stator core 30 and the outer opposing portion 23 and the interval between the one end surface 30a of the stator core 30 and the flange portion 53 of the refrigerant guide member 50 to be absorbed by adjusting the thickness of the first gasket 61.

Each of the plurality of refrigerant passages 35 includes the radial passage 37 and the axial passage 38. Each radial passage 37 communicates with the opening 36 of the refrigerant passage 35 at the one end surface 30a of the stator core 30 and with the axial passage 38. The axial passage 38 is opened at the other end surface 30b of the stator core 30 and extends in the axial direction of the stator 3 towards the radial passage 37 (one end surface 30a). The openings 36 of the plurality of refrigerant passages 35 at the one end surface 30a of the stator core 30 are located outside the openings 39 of the plurality of refrigerant passages 35 at the other end surface 30b of the stator core 30 in the radial direction of the stator 3. As a result, the lubricating cooling oil from the refrigerant supply hole 20o can be distributed by the cylindrical portion 51 of the refrigerant guide member 50, which is disposed radially outside the one coil end portion Ea of the stator coils CU, CV and CW, to the one coil end portion Ea and the stator core 30 side, and supplied to the other coil end portion Eb of the stator coils CU, CV and CW through each refrigerant passage 35.

As has been described above, the rotating electric machine 1 of the present disclosure includes the case body 20, which together with the cover 25 forms the case 2, the annular stator 3 disposed in the case body 20, the rotor 4 rotatably disposed in the stator 3, the plurality of refrigerant passages 35, the refrigerant guide member 50, the first gasket 61 and the second gasket 62. The plurality of refrigerant passages 35 are formed at intervals in the circumferential direction of the stator core 30 so as to extend from one end surface 30a of the stator core 30 of the stator 3 to the other end surface 30b of the stator core 30. The plurality of refrigerant passages 35 are respectively open at the one end surface 30a and the other end surface 30b of the stator core 30. The refrigerant guide member 50 includes the cylindrical portion 51 that surrounds the one coil end portion Ea of the stator coils CU, CV, CW wound around the stator core 30, and the plurality of refrigerant holes 51o formed in the cylindrical portion 51 at intervals in the circumferential direction. The refrigerant guide member 50 guides the lubricating cooling oil (refrigerant) from the refrigerant supply holes 20o formed in the case body 20 to the one coil end portion Ea side and the stator core 30 side. The first gasket 61 seals between the side plate portion 52 of the refrigerant guide member 50 (the end opposite the stator core 30 side) and the case body 20. The second gasket 62 includes the plurality of hole portions 62o formed at intervals in the circumferential direction, each hole portion 62o communicating with the opening 36 of the corresponding refrigerant passage 35 in the one end surface 30a of the stator core 30. The second gasket 62 seals between the one end surface 30a of the stator core 30 and the flange portion 53 (end portion on the stator core 30 side) of the refrigerant guide member 50, and also seals between the one end surface 30a of the stator core 30 and the case body 20. As a result, the coil end portions Ea and Eb of the stator coils CU, CV and CW can be cooled well while suppressing the cost increase of the rotating electric machine 1.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the manufacturing industry of the rotating electric machine.

1. A rotating electric machine comprising:
a case;
an annular stator that includes a stator core and a stator coil wound around the stator core, and is disposed in the case;
a rotor that is rotatably disposed within the stator;
a plurality of refrigerant passages that are formed in the stator core at intervals in a circumferential direction so as to extend from one end surface of the stator core to the other end surface of the stator core, and are respectively opened at the one end surface and the other end surface of the stator core;
a refrigerant guide member that includes a cylindrical portion that surrounds one coil end portion of the stator coil and a plurality of refrigerant holes formed in the cylindrical portion at intervals in the circumferential direction, and guides refrigerant from a refrigerant supply portion formed in the case to the one coil end portion side and the stator core side;
a first sealing member that seals between one end portion of the refrigerant guide member opposite the stator core side and the case; and
a second sealing member that includes a plurality of hole portions formed at intervals in the circumferential direction so as to communicate with an opening in the one end surface of the stator core of the corresponding refrigerant passage, and that seals between the one end surface of the stator core and the other end portion of the stator core side of the refrigerant guide member, as well as sealing between the one end surface of the stator core and the case.

2. The rotating electric machine according to claim 1, wherein:
each of the plurality of hole portions of the second seal member has an opening area larger than the openings of the plurality of refrigerant passages on the one end surface of the stator core.

3. The rotating electric machine according to claim 1, wherein:
the first seal member is attached to the one end portion of the refrigerant guide member; and
the second seal member is attached to the other end portion of the refrigerant guide member.

4. The rotating electric machine according to claim 1, wherein:
the case includes an outer opposing portion that opposes the one end surface of the stator core at an interval in an axial direction of the stator on the stator core side of the refrigerant supply portion; and an inner opposing portion that opposes the one end portion of the refrigerant guide member at an interval in the axial direction on opposite side of the stator core side of the refrigerant supply portion and inside the outer opposing portion in a radial direction of the stator;
the first seal member seals between the one end portion of the refrigerant guide member and the inner opposing portion; and
the second seal member seals between the one end surface of the stator core and the outer opposing portion.

5. The rotating electric machine according to claim 1, wherein:
each of the plurality of refrigerant passages includes an axial passage that is opened at the other end surface of the stator core and extends in an axial direction of the stator toward the one end surface, and a radial passage that communicates the axial passage with the opening of the refrigerant passage on the one end surface of the stator core; and
the openings of the plurality of refrigerant passages on the one end surface of the stator core are located outside in a radial direction of the stator with respect to the openings of the plurality of refrigerant passages on the other end surface of the stator core.
